(19) United States
(12) Patent Application Publication
(10) Pub. No.: US 2023/0290922 A1
(43) Pub. Date: Sep. 14, 2023

(54) BATTERY CELL INCLUDING A SOLID-STATE ELECTROLYTE

(71) Applicant: GM GLOBAL TECHNOLOGY OPERATIONS LLC, Detroit, MI (US)

(72) Inventors: Yong Lu, Shanghai (CN); Zhe Li, Shanghai (CN); Meiyuan Wu, Shanghai (CN); Haijing Liu, Shanghai (CN)

(73) Assignee: GM GLOBAL TECHNOLOGY OPERATIONS LLC, Detroit, MI (US)

(21) Appl. No.: 17/737,089

(22) Filed: May 5, 2022

(30) Foreign Application Priority Data
Mar. 9, 2022 (CN) 202210224083.7

(51) Int. Cl. H01M 4/04; H01M 4/36; H01M 4/485; H01M 10/0525; H01M 10/0562

(52) U.S. Cl. CPC H01M 4/0404; H01M 4/366; H01M 4/485; H01M 10/0525; H01M 10/0562; H01M 2004/021

(57) ABSTRACT

A battery system includes a battery cell, which includes an anode including a first current collector and an anode layer disposed on the first collector and including an anode active material. The cell includes a cathode including a second current collector and a cathode layer disposed on the second collector and including a cathode active material. The cell includes a solid-state electrolyte including one of a reduction tolerable solid electrolyte disposed in contact with the anode and an oxidation tolerable solid electrolyte disposed in contact with the cathode. The reduction tolerable solid electrolyte is present in an amount of from 0.1 part by weight to 5 parts by weight based upon 100 parts by weight of the anode layer. The oxidation tolerable solid electrolyte is present in an amount of from 1 part by weight to 10 parts by weight based upon 100 parts by weight of the cathode layer.

### CROSS REFERENCE TO RELATED APPLICATIONS

This disclosure claims priority to China Patent Application 202210224083.7 filed on Mar. 9, 2022, which is hereby incorporated by reference.

### INTRODUCTION

The disclosure generally relates to a battery cell including a solid-state electrolyte.

Battery cells may include an anode, a cathode, and an electrolyte. A battery cell may operate in charge mode, receiving electrical energy. A battery cell may operate in discharge mode, providing electrical energy. A battery cell may operate through charge and discharge cycles, where the battery first receives and stores electrical energy and then provides electrical energy to a connected system. In vehicles utilizing electrical energy to provide motive force, battery cells of the vehicle may be charged, and then the vehicle may navigate for a period of time, utilizing the stored electrical energy to generate motive force.

A solid-state battery cell includes a solid electrolyte layer or film which provides for chemical reaction between the anode and the cathode. The solid electrolyte is a solid ionic conductor. The solid electrolyte is additionally an insulating material. Particles of the solid electrolyte material may additionally be mixed or blended with materials of both the solid anode and the solid cathode.

### SUMMARY

A battery system is disclosed. The battery system includes a battery cell. The battery cell includes an anode which includes a first current collector and an anode layer disposed on the first current collector and including an anode active material. The battery cell further includes a cathode which includes a second current collector and a cathode layer disposed on the second current collector and including a cathode active material. The battery cell further includes a solid-state electrolyte selected from at least one of a reduction tolerable solid electrolyte disposed in contact with the anode and an oxidation tolerable solid electrolyte disposed in contact with the cathode. The reduction tolerable solid electrolyte is present in the battery cell in an amount of from 0.1 part by weight to 5 parts by weight based upon 100 parts by weight of the anode layer. The oxidation tolerable solid electrolyte is present in the battery cell in an amount of from 1 part by weight to 10 parts by weight based upon 100 parts by weight of the cathode layer.

In some embodiments, the solid-state electrolyte is the reduction tolerable solid electrolyte and includes Li₇₋ₓLa₃Zr₂₋ₓTaₓO₁₂(LLZO).

In some embodiments, the Li₇₋ₓLa₃Zr₂₋ₓTaₓO₁₂ (LLZO) is present in the anode in an amount of from 1 part by weight to 3 parts by weight based upon 100 parts by weight of the anode layer.

In some embodiments, the Li₇₋ₓLa₃Zr₂₋ₓTaₓO₁₂ (LLZO) is present in the anode in an amount of 1 part by weight based upon 100 parts by weight of the anode layer.

In some embodiments, the solid-state electrolyte is the oxidation tolerable solid electrolyte and includes Li_{1+x+y}AlₓTi₂₋ₓSi_{y}P_{3-y}O₁₂ (LATP).

In some embodiments, the Li_{1+x+y}AlₓTi₂₋ₓSi_{y}P_{3-y}O₁₂ (LATP) is present in the cathode in an amount of from 3 parts by weight to 8 parts by weight based upon 100 parts by weight of the cathode layer.

In some embodiments, the Li_{1+x+y}AlₓTi₂₋ₓSi_{y}P_{3-y}O₁₂ (LATP) is present in the cathode in an amount of 5 parts by weight based upon 100 parts by weight of the cathode layer.

In some embodiments, the solid-state is electrolyte includes the reduction tolerable solid electrolyte and the oxidation tolerable solid electrolyte. The reduction tolerable solid electrolyte includes Li₇₋ₓLa₃Zr₂₋ₓTaₓO₁₂(LLZO). The oxidation tolerable solid electrolyte includes Li_{1+x+y}AlₓTi₂₋ₓSi_{y}P_{3-y}O₁₂ (LATP).

In some embodiments, the Li₇₋ₓLa₃Zr₂₋ₓTaₓO₁₂ (LLZO) is present in the anode in an amount of 1 part by weight based upon 100 parts by weight of the anode layer. The Li_{1+x+y}AlₓTi₂₋ₓSi_{y}P_{3-y}O₁₂ (LATP) is present in the cathode in an amount of 5 parts by weight based upon 100 parts by weight of the cathode layer.

In some embodiments, the solid-state electrolyte includes the reduction tolerable solid electrolyte material and the oxidation tolerable solid electrolyte. The reduction tolerable solid electrolyte is intermixed within the anode layer. The oxidation tolerable solid electrolyte is intermixed within the cathode layer.

In some embodiments, the reduction tolerable solid electrolyte further includes a reduction tolerable solid electrolyte layer next to the anode layer. The oxidation tolerable solid electrolyte further includes an oxidation tolerable solid electrolyte layer next to the cathode layer.

In some embodiments, the reduction tolerable solid electrolyte layer next to the anode layer has a thickness of from 0.01 micrometer to 5 micrometers. The oxidation tolerable solid electrolyte layer next to the cathode layer has a thickness of from 0.01 micrometer to 10 micrometers.

In some embodiments, the reduction tolerable solid electrolyte layer next to the anode layer has a thickness of 2 millimeters. The oxidation tolerable solid electrolyte layer next to the cathode layer has a thickness of 7 micrometers.

In some embodiments, the solid-state electrolyte includes the reduction tolerable solid electrolyte material and the oxidation tolerable solid electrolyte. The reduction tolerable solid electrolyte includes a reduction tolerable solid electrolyte layer next to the anode layer. The oxidation tolerable solid electrolyte includes an oxidation tolerable solid electrolyte layer next to the cathode layer.

In some embodiments, the reduction tolerable solid electrolyte layer next to the anode layer has a thickness of from 0.01 micrometer to 5 micrometers. The oxidation tolerable solid electrolyte layer next to the cathode layer has a thickness of from 0.01 micrometer to 10 micrometers.

In some embodiments, the reduction tolerable solid electrolyte layer next to the anode layer has a thickness of 2 millimeters. The oxidation tolerable solid electrolyte layer next to the cathode layer has a thickness of 7 micrometers.

In some embodiments, the solid-state electrolyte is the reduction tolerable solid electrolyte and includes a garnet type solid electrolyte.

In some embodiments, the solid-state electrolyte is the reduction tolerable solid electrolyte and is selected from the group consisting of a sodium super ionic conductor-type solid electrolyte, a garnet type solid electrolyte, and Li₃ₓLa_{2/3-x}TiO₃.

According to one alternative embodiment, a device is provided. The device includes a motor generator unit of a powertrain and a battery system configured for providing electrical energy to the motor generator unit. The battery system includes a battery cell. The battery cell includes an anode which includes a first current collector and an anode layer disposed on the first current collector and including an anode active material. The battery cell further includes a cathode which includes a second current collector and a cathode layer disposed on the second current collector and including a cathode active material. The battery cell further includes a solid-state electrolyte selected from at least one of a reduction tolerable solid electrolyte disposed in contact with the anode and an oxidation tolerable solid electrolyte disposed in contact with the cathode. The reduction tolerable solid electrolyte is present in the battery cell in an amount of from 0.1 part by weight to 5 parts by weight based upon 100 parts by weight of the anode layer. The oxidation tolerable solid electrolyte is present in the battery cell in an amount of from 1 part by weight to 10 parts by weight based upon 100 parts by weight of the cathode layer.

In some embodiments, the solid-state electrolyte includes the reduction tolerable solid electrolyte and the oxidation tolerable solid electrolyte. The reduction tolerable solid electrolyte includes Li₇₋ₓLa₃Zr₂₋ₓTaₓO₁₂(LLZO). The oxidation tolerable solid electrolyte includes Li_{1+x+y}AlₓTi₂₋ₓSi_{y}P_{3-y}O₁₂ (LATP).

The above features and advantages and other features and advantages of the present disclosure are readily apparent from the following detailed description of the best modes for carrying out the disclosure when taken in connection with the accompanying drawings.

### BRIEF DESCRIPTION OF THE DRAWINGS

FIG. 1 schematically illustrates in cross section an exemplary battery system including a battery cell that includes a solid electrolyte, in accordance with the present disclosure;

FIG. 2 schematically illustrates in cross section a portion of the battery cell of FIG. 1, wherein material of a solid electrolyte is intermixed with active materials upon an electrode, in accordance with the present disclosure;

FIG. 3 schematically illustrates in cross section an alternative embodiment of a portion of the battery cell of FIG. 1, wherein the solid electrolytes are disposed as separate layers next to each of the electrodes, in accordance with the present disclosure;

FIG. 4 schematically illustrates in cross section an alternative portion of a portion of the battery cell of FIG. 1, wherein material of a solid electrolyte is intermixed with active materials upon one of the electrodes and further solid electrolyte layers are disposed next to each of the electrodes, in accordance with the present disclosure;

FIG. 5 is a graph illustrating exemplary test results describing electrochemical impedance spectroscopy of a battery with a control gel electrolyte and a second battery with the gel electrolyte and Li₇₋ₓLa₃Zr₂₋ₓTaₓO₁₂ (LLZO) present within the second battery, in accordance with the present disclosure;

FIG. 6 is a graph illustrating exemplary test results describing direct current polarization of a battery with a control gel electrolyte and a second battery with the gel electrolyte and LLZO present within the second battery, in accordance with the present disclosure;

FIG. 7 is a graph illustrating exemplary test results describing electrochemical impedance spectroscopy of a battery with a control electrolyte composition at three different operation states, in accordance with the present disclosure;

FIG. 8 is a graph illustrating exemplary test results describing direct current polarization of a battery with a control gel electrolyte and a second battery with the gel electrolyte and LLZO present within the battery, in accordance with the present disclosure;

FIG. 9 is a graph illustrating exemplary test results showing battery capacity retention of batteries with various amounts of LATP in the cathodes of the batteries at room temperature, in accordance with the present disclosure;

FIG. 10 is a graph illustrating exemplary test results showing battery capacity retention of batteries with various amounts of LATP in the cathodes of the batteries at high temperature, in accordance with the present disclosure;

FIG. 11 is a graph illustrating exemplary test results showing battery capacity retention of batteries with various amounts of LLZO in the anodes of the batteries at room temperature, in accordance with the present disclosure;

FIG. 12 is a graph illustrating exemplary test results showing battery capacity retention of batteries with various amounts of LLZO in the anodes of the batteries at high temperature, in accordance with the present disclosure; and

FIG. 13 schematically illustrates an exemplary device including the battery system of FIG. 1 including a plurality of battery cells, in accordance with the present disclosure.

### DETAILED DESCRIPTION

Solid-state electrolytes (SE) or solid electrolytes may have a benefit of facilitating ionic dissociation of a gel or liquid electrolyte, thereby boosting ionic transport. A battery including a solid-state electrolyte includes one or more solid electrolytes. Reactions between the SEs and a gel or liquid electrolyte may reduce efficiency of cell cycling, in particular, at high temperatures, such as at 45° C.

A battery system including a battery cell is provided that includes an anode, a reduction tolerable solid electrolyte disposed in contact with the anode, a cathode, and an oxidation tolerable solid electrolyte disposed in contact with the cathode. The disclosed battery system, battery cell, and device provides excellent power capability at low temperature and room temperature, and additionally offers excellent high temperature durability. SEs are provided in electrode layers with a first solid electrolyte, in the cathode and with a second solid electrolyte, in the anode. The solid electrolytes may be provided with electrolyte material intermixed with active materials upon the electrode, as a separate layer next to the electrode, or both as electrolyte material intermixed with the electrode and with a separate layer next to the electrode.

According to one embodiment, a battery system is disclosed. The battery system includes a battery cell. The battery cell includes an anode which includes a first current collector and an anode layer disposed on the first current collector and including an anode active material. The battery cell further includes a cathode which includes a second current collector and a cathode layer disposed on the second current collector and including a cathode active material. The battery cell further includes a solid-state electrolyte selected from at least one of a reduction tolerable solid electrolyte disposed in contact with the anode and an oxidation tolerable solid electrolyte disposed in contact with the cathode. The reduction tolerable solid electrolyte is present in the battery cell in an amount of from 0.1 part by weight to 5 parts by weight based upon 100 parts by weight of the anode layer. The oxidation tolerable solid electrolyte is present in the battery cell in an amount of from 1 part by weight to 10 parts by weight based upon 100 parts by weight of the cathode layer.

A number of oxidation tolerable solid electrolytes may be utilized for, in, or upon the cathode. In a first example, Li_{1+x+y}AlₓTi₂₋ₓSi_{y}P_{3-y}O₁₂ (LATP) may be utilized. In a second example, a sodium super ionic conductor-type (NASICON-type) solid electrolyte including Li₁₊ₓAlₓM₂₋ₓ(PO₄)₃ (wherein M=Ti or Ge) or Li_{1+x+y}AlₓTi₂₋ₓSi_{y}P_{3-y}O₁₂ may be utilized. In a third example, a garnet type solid electrolyte including Li₇La₃Zr₂O₁₂ or Li₇₋ₓLa₃Zr₂₋ₓMₓO₁₂ (LLZO, wherein M=Ta, Nb, Bi, Sn, etc.) In a fourth example, Li₃ₓLa_{2/3-x}TiO₃ may be utilized. The disclosed solid electrolytes may be utilized with or without surface treatments or doping.

In one embodiment, an electrode may include the cathode including a second current collector (which may include a sheet of conductive metal such as copper or aluminum) and a cathode coating or layer, which includes active material and may include conductive additives and a binder. The cathode coating may have a thickness from 10 micrometers to 200 micrometers. When a solid electrolyte layer is provided next to the cathode, the solid electrolyte layer may have a thickness from 0.01 micrometers to 10 micrometers. In one embodiment, the solid electrolyte layer may have a thickness of 7 micrometers. In one embodiment, the solid electrolyte layer may have a thickness equivalent to 2 layers to 3 layers of the solid electrolyte particles.

The cathode active material may include an olivine-type active material, such as LiFePO₄ or LiMnₓFe₁₋ₓPO₄. In another example, the cathode active material may include rock salt layered oxides, for example including LiCoO₂, LiNiₓMn_{y}Co_{1-x-y}O₂, LiNiₓMn_{y}Al_{1-x-y}O₂, LiNiₓMn₁₋ₓO₂, or Li₁₊ₓMO₂. In another example, the cathode active material may include a spinel, such as LiMn₂O₄ or LiNi_{0.5}Mn_{1.5}O₄. In another example, the cathode active material may include a polyanion cathode, such as LiV₂(PO₄)₃. In another example, the cathode active material may include other lithium transition-metal oxides. In another example, the cathode active material may include a combination of aforementioned cathode active materials.

The cathode materials provided as examples herein may be surface coated or doped, for example, LiNbO₃-coated LiNiₓMn_{y}Co_{1-x-y}O₂ and Al-doped LiNiₓMn_{y}Co_{1-x-y}O₂.

Cathode binder materials may include poly(vinylidene fluoride) (PVDF), poly(vinylidene fluoride-co-hexafluoropropylene) (PVdF-HFP), poly(tetrafluoroethylene (PTFE), sodium carboxymethyl cellulose (CMC), styrene-butadiene rubber (SBR), and nitrile butadiene rubber (NBR).

Conductive additives utilized in the cathode may include carbon black, graphite, graphene, graphene oxide, acetylene black, carbon nanofibers, carbon nanotubes, and other electrically conductive additive. The conductive additives may include Super P which is commercially available through Imerys Graphite and Carbon Switzerland SA of Bodio, Switzerland.

In one embodiment, a solid electrolyte such as LATP may be provided from 1 part by weight to 10 parts by weight based upon 100 parts by weight in the cathode as compared to a total weight of the cathode layer or the cathode not including the current collector, with the cathode additionally including cathode active material at 30 parts by weight to 98 parts by weight based upon 100 parts by weight in the electrode, conductive additive at 0 parts by weight to 30 parts by weight based upon 100 parts by weight in the electrode, and binder at 0 parts by weight to parts by weight based upon 100 parts by weight in the electrode. In another embodiment, LATP may be provided from 3 parts by weight to 8 parts by weight in the cathode based upon 100 parts by weight in the electrode. In another embodiment, LATP may be provided at 5 parts by weight in the cathode based upon 100 parts by weight in the electrode.

In the disclosed battery system, the oxidation tolerable solid electrolyte may include Li_{1+x+y}AlₓTi₂₋ₓSi_{y}P_{3-y}O₁₂ (LATP). The Li_{1+x+y}AlₓTi₂₋ₓSi_{y}P_{3-y}O₁₂ (LATP) may be present in the cathode in an amount of from 3 parts by weight to 8 parts by weight based upon 100 parts by weight of the cathode layer. The Li_{1+x+y}AlₓTi₂₋ₓSi_{y}P_{3-y}O₁₂ (LATP) may be present in the cathode in an amount of 5 parts by weight based upon 100 parts by weight of the cathode layer.

A number of reduction tolerable solid electrolytes may be utilized for, in, or upon the anode. In a first example, Li₇₋ₓLa₃Zr₂₋ₓTaₓO₁₂ (LLZO) may be utilized. In a second example, a garnet type solid electrolyte including Li₇La₃Zr₂O₁₂ or Li₇₋ₓLa₃Zr₂₋ₓMO₁₂ (LLZO, M=Ta, Nb, Bi, Sn, etc.) may be utilized, with or without surface treatments or doping.

In one embodiment, an electrode may include the cathode including a current collector (which may include a sheet of conductive metal such as copper or aluminum) and an anode coating or layer, which includes active material and may include conductive additives and binder. The anode coating may have a thickness from 10 micrometers to 200 micrometers. When a solid electrolyte layer is provided next to the cathode, the solid electrolyte layer may have a thickness from 00.1 micrometers to 5 micrometers. In one embodiment, the solid electrolyte layer may have a thickness of 2 micrometers. In one embodiment, the solid electrolyte layer may have a thickness equivalent to 2 layers to 3 layers of the solid electrolyte particles.

The anode active material may include carbonaceous material, for example, including graphite, hard carbon, or soft carbon. In another example, the anode active material may include silicon or silicon mixed with graphite. In another example, the anode active material may include Li₄Ti₅O₁₂, a transition metal (for example, tin), a metal oxide such as TiO₂, a metal sulfide such as FeS, or other lithium accepting anode materials. In another example, the anode active material may include lithium metal or a lithium alloy. In another example, the anode active material may include a combination of aforementioned anode active materials.

Anode binder materials may include PVDF, PVdF-HFP, PTFE, CMC, styrene-butadiene rubber (SBR), and nitrile butadiene rubber (NBR).

Conductive additives utilized in the anode may include carbon black, graphite, graphene, graphene oxide, acetylene black, carbon nanofibers, carbon nanotubes, and other electrically conductive additive. The conductive additives may include Super P which is commercially available through Imerys Graphite and Carbon Switzerland SA of Bodio, Switzerland.

In one embodiment, a solid electrolyte such as LLZO may be provided from 0.1 parts by weight to 5 parts by weight in the anode as based upon 100 parts in the anode, based upon a total weight of the anode coating or the anode not including the current collector, with the anode additionally including anode active material at 30 parts by weight to 98 parts by weight based upon 100 parts in the anode, conductive additive at 0 parts by weight to 30 parts by weight based upon 100 parts in the anode, and binder at 0 parts by weight to 20 parts by weight based upon 100 parts in the anode. In another embodiment, LLZO may be provided from 1 part by weight to 3 parts by weight in the anode based upon 100 parts in the anode. In another embodiment, LLZO may be provided at 1 part by weight in the anode based upon 100 parts in the anode.

The reduction tolerable solid electrolyte may be a garnet type solid electrolyte.

The reduction tolerable solid electrolyte may be selected from the group consisting of a sodium super ionic conductor-type solid electrolyte, a garnet type solid electrolyte, and Li₃ₓLa_{2/3-x}TiO₃.

Liquid electrolytes and/or gel electrolytes may further be provided within the battery cell. For example, 5% poly(vinylidene fluoride-co-hexafluoropropylene) (PVDF-HFP)+95% [0.4 mole lithium bis(trifluoromethanesulfonyl)imide (LiTFSI) and 0.4 molar lithium tetrafluoroborate (LiBF4) in a solvent including ethylene carbonate (EC)/γ-butyrolactone (GBL) at 0.4/0.6 (as weight/weight) may be included.

LLZO under electrical field may be described as a polarized solid electrolyte. Polarized solid electrolytes promote dissociation of lithium salt and boosting of lithium-ion transportation, especially at low temperature, which increases reactivity on interfaces.

In the disclosed battery system, the reduction tolerable solid electrolyte may include Li₇₋ₓLa₃Zr₂₋ₓTaₓO₁₂(LLZO). The Li₇₋ₓLa₃Zr₂₋ₓTaₓO₁₂ (LLZO) may be present in the anode in an amount of from 1 part by weight to 3 parts by weight based upon 100 parts by weight of the anode layer. The Li₇₋ₓLa₃Zr₂₋ₓTaₓO₁₂ (LLZO) may be present in the anode in an amount of 1 part based upon 100 parts by weight of the anode layer.

In the disclosed battery system, the reduction tolerable solid electrolyte may include Li₇₋ₓLa₃Zr₂₋ₓTaₓO₁₂(LLZO), and the oxidation tolerable solid electrolyte may include Li_{1+x+y}AlₓTi₂₋ₓSi_{y}P_{3-y}O₁₂ (LATP). The Li₇₋ₓLa₃Zr₂₋ₓTaₓO₁₂ (LLZO) may be present in the anode in an amount of 1 part by weight based upon 100 parts by weight of the anode layer. The Li_{1+x+y}AlₓTi₂₋ₓSi_{y}P_{3-y}O₁₂ (LATP) may be present in the cathode in an amount of 5 parts by weight based upon 100 parts by weight of the cathode layer.

In the disclosed battery system, the reduction tolerable solid electrolyte may include reduction tolerable solid electrolyte material intermixed within the anode layer, and the oxidation tolerable solid electrolyte may include oxidation tolerable solid electrolyte material intermixed within the cathode layer. The reduction tolerable solid electrolyte further may include a reduction tolerable solid electrolyte layer next to the anode layer. The oxidation tolerable solid electrolyte further may include an oxidation tolerable solid electrolyte layer next to the cathode layer. The reduction tolerable solid electrolyte layer next to the anode layer may have a thickness from 0.01 micrometers to 5 micrometers. The oxidation tolerable solid electrolyte layer next to the cathode layer may have a thickness from 0.01 micrometers to 10 micrometers. The reduction tolerable solid electrolyte layer next to the anode layer may have a thickness of 2 millimeters. The oxidation tolerable solid electrolyte layer next to the cathode layer may have a thickness of 7 micrometers.

In the disclosed battery system, the reduction tolerable solid electrolyte may include a reduction tolerable solid electrolyte layer next to the anode layer. The oxidation tolerable solid electrolyte may include an oxidation tolerable solid electrolyte layer next to the cathode layer. The reduction tolerable solid electrolyte layer next to the anode layer may have a thickness from 0.01 micrometers to 5 micrometers. The oxidation tolerable solid electrolyte layer next to the cathode layer may have a thickness from 0.01 micrometers to 10 micrometers. The reduction tolerable solid electrolyte layer next to the anode layer may have a thickness of 2 millimeters. The oxidation tolerable solid electrolyte layer next to the cathode layer may have a thickness of 7 micrometers.

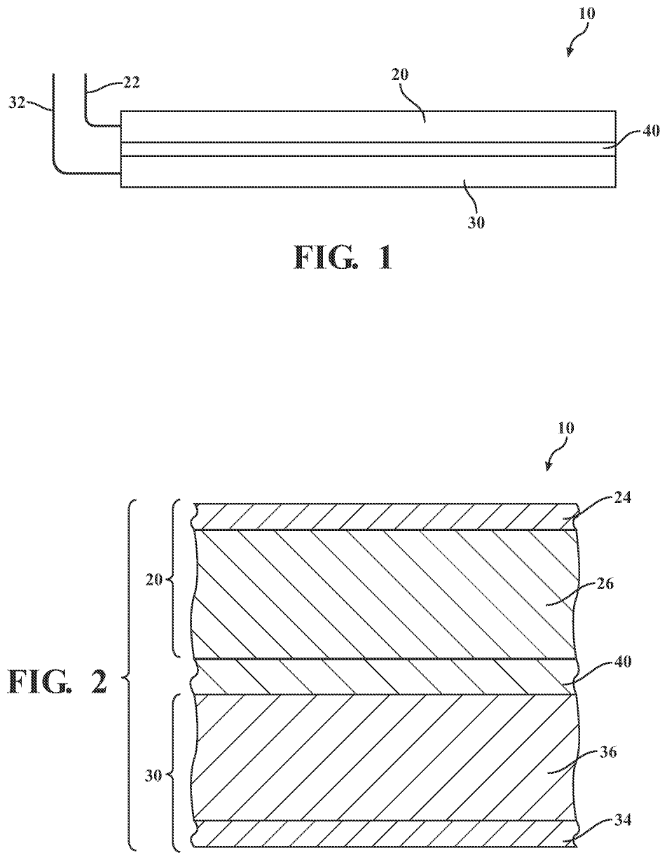

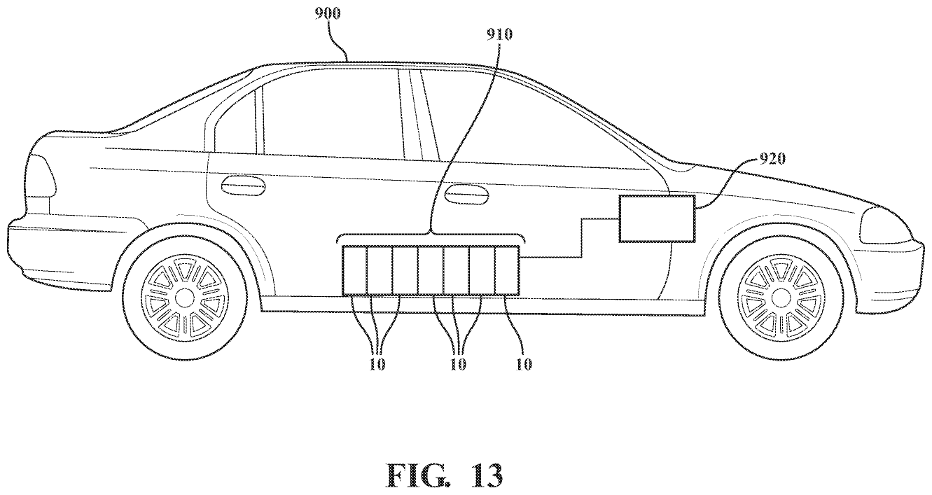

Referring now to the drawings, wherein like reference numbers refer to like features throughout the several views, FIG. 1 schematically illustrates an exemplary battery system 5 including a solid-state battery cell 10 that includes an anode 20, a cathode 30, and a separator 40. The battery cell 10 enables converting electrical energy into stored chemical energy in a charging cycle, and the battery cell enables converting stored chemical energy into electrical energy in a discharging cycle. A negative electrical lead 22 and a positive electric lead 32 are illustrated connected to the anode 20 and the cathode 30, respectively. Battery cell 10 provides electrical energy through the negative electrical lead 22 and the positive electrical lead 32. A plurality of battery cells 10 may be provided in series and/or in parallel to provide or deliver electrical energy to a connected system such as a powertrain element, e.g., a motor generator unit 920 (FIG. 13). The separator 40 enables ion transfer between the anode 20 and the cathode 30.

A first solid electrolyte is provided with the cathode 30. The first solid electrolyte may be provided as solid electrolyte material interspersed within a cathode layer of the cathode 30, as a separate layer next to the cathode layer of the cathode 30, or as both solid electrolyte material interspersed within a cathode layer of the cathode 30 and as a separate layer next to the cathode layer of the cathode 30.

A second solid electrolyte is provided with the anode 20. The second solid electrolyte may be provided as solid electrolyte material interspersed within an anode layer of the anode 20, as a separate layer next to the anode layer of the anode 20, or as both solid electrolyte material interspersed within an anode layer of the anode 20 and as a separate layer next to the anode layer of the anode 20.

In one embodiment, a gel electrolyte is utilized to build up favorable lithium-ion conduction paths between solid-solid contacts in the anode 20. The gel electrolyte may be present in a trace amount, or the gel electrolyte may be present in significantly higher quantity than the solid electrolyte. In one embodiment, a weight of the gel electrolyte may be 10% of a total weight of the solid electrolyte and the gel electrolyte. The gel electrolyte may include a polymer host (0.1%-50% (by weight)) and a liquid electrolyte (5%-90% (by weight)). The polymer host may include one or more of poly(ethylene oxide)s, poly(vinylidene fluoride-co-hexafluoropropylene)s, poly(methyl methacrylate)s, carboxymethyl cellulose, polyacrylonitrile, polyvinylidene difluoride, poly(vinyl alcohol), or polyvinylpyrrolidone.

The gel electrolyte may include a lithium salt and a solvent. The lithium salt includes a lithium cation and may include one of more of hexafluoroarsenate; hexafluorophosphate; bis(fluorosulfonyl)imide; perchlorate; tetrafluoroborate; cyclo-difluoromethane-1,1-bis(sulfonyl)imide; bis(trifluoromethanesulfonyl)imide; bis(perfluoroethanesulfonyl)imide; bis(oxalate)borate; difluoro(oxalato)borate; and bis(fluoromalonato)borate. The solvent dissolves the lithium salt enabling excellent lithium-ion conductivity. Additionally, the solvent may be selected based upon a relatively low vapor pressure in accordance with a typical fabrication process. The solvent may be selected from one of a carbonate solvent, a lactone, a nitrile, a sulfone, an ether, a phosphate, or an ionic liquid.

FIG. 2 schematically illustrates in cross section a portion of the battery cell 10 of FIG. 1, wherein material of a solid electrolyte is intermixed with active materials upon at least one of the electrodes. The battery cell 10 is illustrated including the anode 20, the cathode 30, and the separator 40. The anode 20 includes a first current collector 24 and an anode layer 26. The anode layer 26 includes an active material and may include an electrically conductive additive and a binder. In the embodiment of FIG. 2, the anode layer 26 further includes a solid electrolyte material intermixed with the other components of the anode layer 26.

The cathode 30 includes a second current collector 34 and a cathode layer 36. The cathode layer 36 includes an active material and may include an electrically conductive additive and a binder. In the embodiment of FIG. 2, the cathode layer 36 further includes a solid electrolyte material intermixed with the other components of the cathode layer 36.

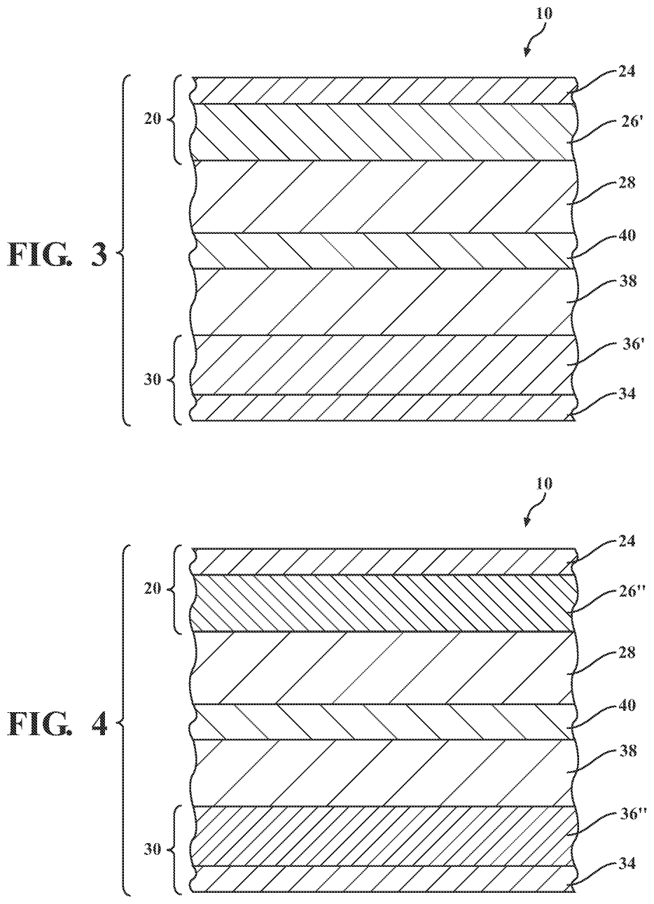

FIG. 3 schematically illustrates in cross section an alternative embodiment of a portion of the battery cell of FIG. 1, wherein the solid electrolytes are disposed as separate layers next to each of the electrodes. The battery cell 10 is illustrated including the anode 20, the cathode 30, and the separator 40. The anode 20 includes the first current collector 24 and an anode layer 26′. The anode layer 26′ includes an active material and may include an electrically conductive additive and a binder. In the embodiment of FIG. 3, a solid electrolyte layer 28 is disposed next to the anode layer 26′.

The cathode 30 includes the second current collector 34 and a cathode layer 36′. The cathode layer 36′ includes an active material and may include an electrically conductive additive and a binder. In the embodiment of FIG. 3, a solid electrolyte layer 38 is disposed next to the cathode layer 36′.

FIG. 4 schematically illustrates in cross section an alternative portion of a portion of the battery cell of FIG. 1, wherein material of a solid electrolyte is intermixed with active materials upon one of the electrodes and further solid electrolyte layers are disposed next to each of the electrodes. The battery cell 10 is illustrated including the anode 20, the cathode 30, and the separator 40. The anode 20 includes the first current collector 24 and an anode layer 26″. The anode layer 26″ includes an active material and may include an electrically conductive additive and a binder. In the embodiment of FIG. 4, the anode layer 26″ further includes a solid electrolyte material intermixed with the other components of the anode layer 26″. Additionally, a solid electrolyte layer 28 is disposed next to the anode layer 26″.

The cathode 30 includes the second current collector 34 and a cathode layer 36″. The cathode layer 36″ includes an active material and may include an electrically conductive additive and a binder. In the embodiment of FIG. 4, the cathode layer 36″ further includes a solid electrolyte material intermixed with the other components of the cathode layer 36″. Additionally, a solid electrolyte layer 38 is disposed next to the cathode layer 36″.

FIG. 5 is a graph 100 illustrating exemplary test results describing electrochemical impedance spectroscopy (EIS) of a battery with a control gel electrolyte and a second battery with the gel electrolyte and LLZO present within the battery. The test is operated at 25° C. The axes represent Nyquist plots representing negative of the imaginary (vertical axis 104) versus real parts (horizontal axis 102) of the complex impedance of individual electrodes or electrochemical cells. Plot 120 includes performance of the battery with the control gel electrolyte. Plot 130 includes performance of the battery with the gel electrolyte and the LLZO. The testing results illustrate that the battery with the LLZO exhibits slightly enhanced ionic transport inside electrodes and decreased interfacial impedance.

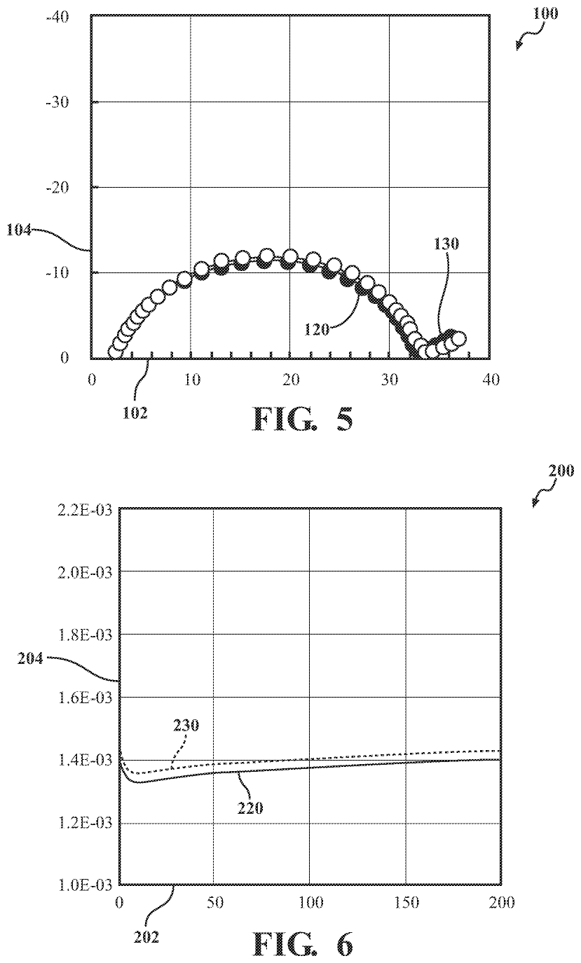

FIG. 6 is a graph 200 illustrating exemplary test results describing direct current polarization of a battery with a control gel electrolyte and a second battery with the gel electrolyte and LLZO present within the battery. The test is operated at 25° C. at 50 millivolts. A vertical axis 204 illustrates current in Amps per square centimeter of the counter electrodes. A horizontal axis 202 illustrate time in seconds. Plot 220 illustrates test results for the battery including the control gel electrolyte. Plot 230 illustrates test results for the battery including the gel electrolyte and the LLZO. The testing results illustrate that the battery with the LLZO exhibits that the LLZO is more likely to be polarized to trigger side reactions, delivering slightly higher current.

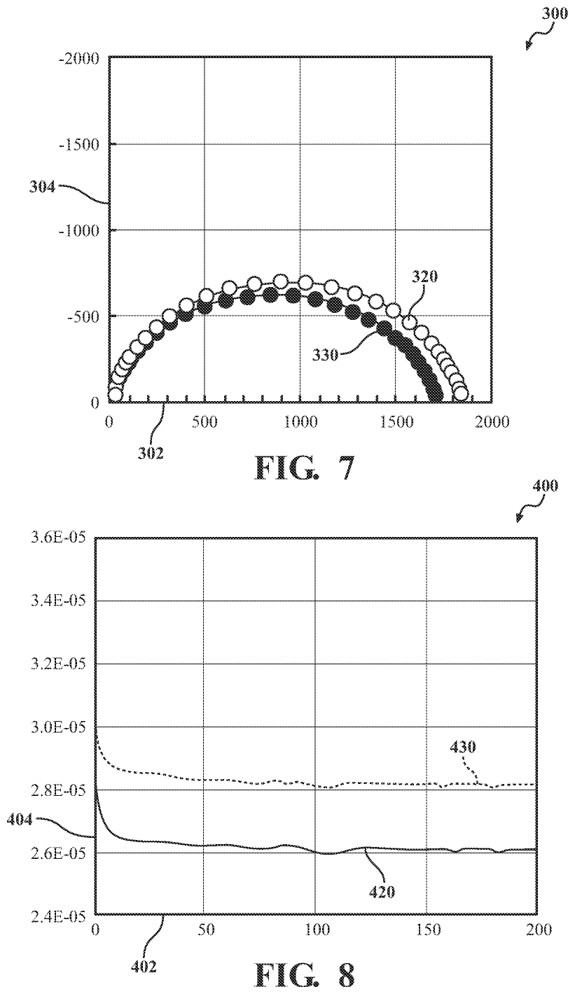

FIG. 7 is a graph 300 illustrating exemplary test results describing EIS of a battery with a control electrolyte composition at three different operation states. The test is operated at −18° C. The axes represent Nyquist plots representing negative of the imaginary (vertical axis 304) versus real parts (horizontal axis 302) of the complex impedance of individual electrodes or electrochemical cells. Plot 320 includes performance of the battery with the control gel electrolyte. Plot 330 includes performance of the battery with the gel electrolyte and the LLZO. The testing results illustrate that the battery with the LLZO exhibits much better interfacial ionic transportation at low temperature arising from the fast lithium-ion dissociation contributing by the LLZO particles.

FIG. 8 is a graph 400 illustrating exemplary test results describing direct current polarization of a battery with a control gel electrolyte and a second battery with the gel electrolyte and LLZO present within the battery. The test is operated at −18° C. at 50 millivolts. A vertical axis 404 illustrates current in Amps per square centimeter of the anode. A horizontal axis 402 illustrate time in seconds. Plot 420 illustrates test results for the battery including the control gel electrolyte. Plot 430 illustrates test results for the battery including the gel electrolyte and the LLZO. The testing results illustrate that the battery with the LLZO is potentially to bring about more side reactions due to the polarized LLZO although the general reaction thermodynamics of the gel electrolyte is slow at low temperature. Reviewing the results of FIGS. 5-8, one may see that polarized electrolytes, such as LLZO, will promote dissociation of lithium salt and boosting lithium-ion transportation, which additionally will bring about reactivity on the interfaces.

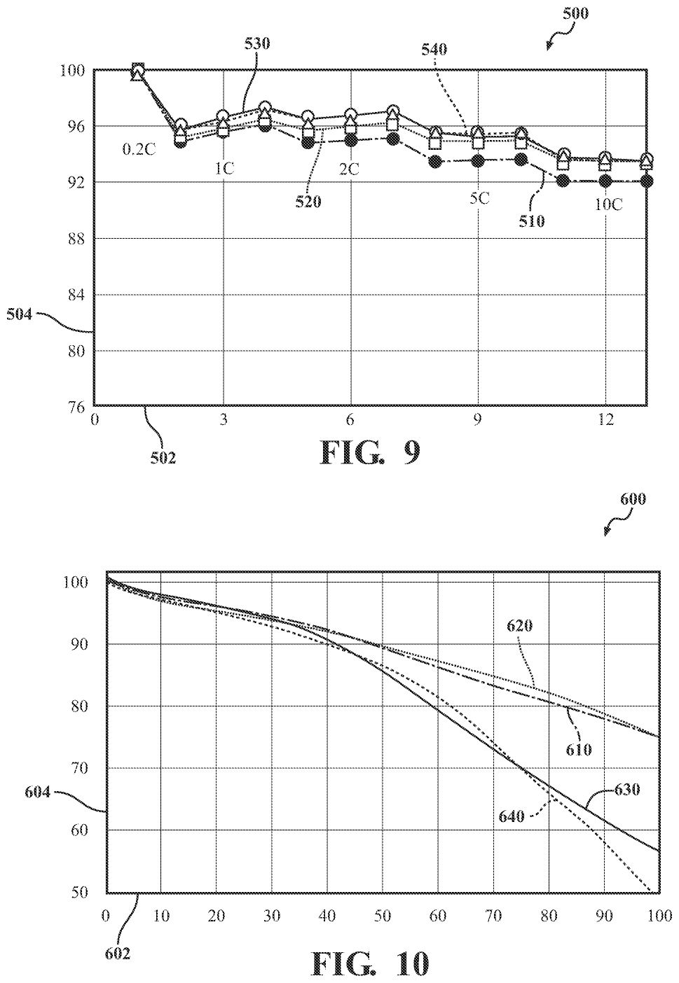

FIG. 9 is a graph 500 illustrating exemplary test results showing battery discharge rate capacity retention of batteries with various amounts of LATP in the cathodes of the batteries at room temperature. A vertical axis 504 is illustrated representing battery capacity retention in percentage. A horizontal axis 502 is illustrated representing a number of charge and discharge cycles through which the battery is operated. The test is operated at 25° C. The charge rate is fixed and 1C and discharge at 1C, 2C, 5C and 10C. Plot 510 illustrates a control battery with 0% LATP present by weight. Plot 520 illustrates a battery with 5% LATP present by weight. Plot 530 illustrates a battery with 10% LATP present by weight. Plot 540 illustrates a battery with 20% LATP present by weight. One may see in the test results improvement in battery capacity retention in plot 520, plot 530, and plot 540 as compared to plot 510, implying improved discharge rate capability by applying solid electrolyte into the electrodes. The batteries with 5%, 10%, and 20% LATP by weight show excellent improvement in battery capacity retention through the illustrated series of charging and discharging cycles at room temperature.

FIG. 10 is a graph 600 illustrating exemplary test results showing battery capacity retention of batteries with various amounts of LATP in the cathodes of the batteries at high temperature and 1C charge-discharge rate. A vertical axis 604 is illustrated representing battery capacity retention in percentage. A horizontal axis 602 is illustrated representing a number of charge and discharge cycles through which the battery is operated. The test is operated at 1C or at the current capacity of the battery at 45 ° C. Plot 610 illustrates a control battery with 0% LATP present by weight. Plot 620 illustrates a battery with 5% LATP present by weight. Plot 630 illustrates a battery with 10% LATP present by weight. Plot 640 illustrates a battery with 20% LATP present by weight. One may see in the test results improvement or similarity in battery capacity retention in plot 620 as compared to plot 610. One may see in the test results a rapid fall-off in capacity retention related to plot 630 and plot 640 as compared to plot 610. The battery with 5% LATP by weight shows acceptable performance in relation to the control battery of plot 610, whereas the batteries with 10% and 20% LATP by weight show decreased battery capacity retention as compared to the control battery of plot 610. Reviewing the results of FIGS. 9 and 10, one may see that a battery with 5% LATP present in the cathode illustrates improved battery capacity retention at room temperature while maintaining excellent performance at high temperature.

FIG. 11 is a graph 700 illustrating exemplary test results showing battery discharge rate capacity retention of batteries with various amounts of LLZO in the anodes of the batteries at room temperature. A vertical axis 704 is illustrated representing battery capacity retention in percentage. A horizontal axis 702 is illustrated representing a number of charge and discharge cycles through which the battery is operated. The test is operated at 25° C. The charge rate is fixed and 1C and discharge at 1C, 2C, 5C and 10C. Plot 710 illustrates a control battery with 0% LLZO present by weight. Plot 720 illustrates a battery with 1% LLZO present by weight. Plot 730 illustrates a battery with 5% LLZO present by weight. Plot 740 illustrates a battery with 10% LLZO present by weight. One may see in the test results improvement in battery capacity retention in plot 720 and plot 730 as compared to plot 710. One may further see a similar battery capacity retention in the plot 740 as compared to plot 710. The batteries with 1% and 5% LLZO by weight show excellent improvement in battery discharge rate capability through the illustrated series of charging and discharging cycles at room temperature.

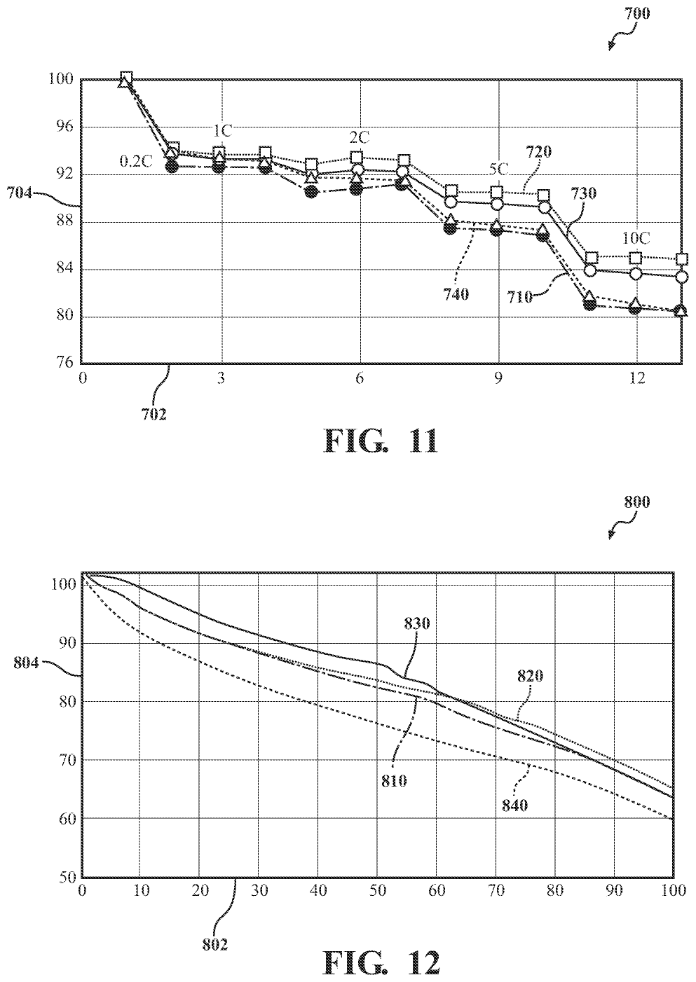

FIG. 12 is a graph 800 illustrating exemplary test results showing battery capacity retention of batteries with various amounts of LLZO in the anodes of the batteries at high temperature and 1C charge-discharge rate. A vertical axis 804 is illustrated representing battery capacity retention in percentage. A horizontal axis 802 is illustrated representing a number of charge and discharge cycles through which the battery is operated. The test is operated at 1C or at the current capacity of the battery at 45° C. Plot 810 illustrates a control battery with 0% LLZO present by weight. Plot 820 illustrates a battery with 1% LLZO present by weight. Plot 830 illustrates a battery with 5% LLZO present by weight. Plot 840 illustrates a battery with 10% LLZO present by weight. One may see in the test results improvement or similarity in battery capacity retention in plot 820 as compared to plot 810. One may see in the test results decreased performance in capacity retention related to plot 830 and plot 840 as compared to plot 810. The battery with 1% LLZO by weight shows acceptable performance in relation to the control battery of plot 810, whereas the batteries with 5% and 10% LLZO by weight show decreased battery capacity retention as compared to the control battery of plot 810. Reviewing the results of FIGS. 11 and 12, one may see that a battery with 1% LLZO present in the anode illustrates improved battery discharge rate capability at room temperature while maintaining excellent performance at high temperature.

The battery system 5 and the battery cell 10 may be utilized in a wide range of applications and powertrains. FIG. 13 schematically illustrates an exemplary device 900 including, e.g., a battery electric vehicle (BEV), including a battery pack 910 that includes a plurality of battery cells 10. The plurality of battery cells 10 may be connected in various combinations, for example, with a portion being connected in parallel and a portion being connected in series, to achieve goals of supplying electrical energy at a desired voltage. The battery pack 910 is illustrated as electrically connected to a motor generator unit 920 useful to provide motive force to the device 900. The motor generator unit 920 may include an output component, for example, an output shaft, which is provided mechanical energy useful to provide the motive force to the device 900. A number of variations to device 900 are envisioned, and the disclosure is not intended to be limited to the examples provided.

While the best modes for carrying out the disclosure have been described in detail, those familiar with the art to which this disclosure relates will recognize various alternative designs and embodiments for practicing the disclosure within the scope of the appended claims.

What is claimed is:

1. A battery system comprising:
a battery cell, including:
an anode including:
a first current collector; and
an anode layer disposed on the first current collector and including an anode active material;
a cathode including:
a second current collector; and
a cathode layer disposed on the second current collector and including a cathode active material; and
a solid-state electrolyte selected from at least one of a reduction tolerable solid electrolyte disposed in contact with the anode and an oxidation tolerable solid electrolyte disposed in contact with the cathode;
wherein the reduction tolerable solid electrolyte is present in the battery cell in an amount of from 0.1 part by weight to 5 parts by weight based upon 100 parts by weight of the anode layer; and
wherein the oxidation tolerable solid electrolyte is present in the battery cell in an amount of from 1 part by weight to 10 parts by weight based upon 100 parts by weight of the cathode layer.

2. The battery system of claim 1, wherein the solid-state electrolyte is the reduction tolerable solid electrolyte and includes Li₇₋ₓLa₃Zr₂₋ₓTaₓO₁₂ (LLZO).

3. The battery system of claim 2, wherein the Li₇₋ₓLa₃Zr₂₋ₓTaₓO₁₂ (LLZO) is present in the anode in an amount of from 1 part by weight to 3 parts by weight based upon 100 parts by weight of the anode layer.

4. The battery system of claim 2, wherein the Li₇₋ₓLa₃Zr₂₋ₓTaₓO₁₂ (LLZO) is present in the anode in an amount of 1 part by weight based upon 100 parts by weight of the anode layer.

5. The battery system of claim 1, wherein the solid-state electrolyte is the oxidation tolerable solid electrolyte and includes Li_{1+x+y}AlₓTi₂₋ₓSi_{y}P_{3-y}O₁₂ (LATP).

6. The battery system of claim 5, wherein the Li_{1+x+y}AlₓTi₂₋ₓSi_{y}P_{3-y}O₁₂ (LATP) is present in the cathode in an amount of from 3 parts by weight to 8 parts by weight based upon 100 parts by weight of the cathode layer.

7. The battery system of claim 6, wherein the Li_{1+x+y}AlₓTi₂₋ₓSi_{y}P_{3-y}O₁₂ (LATP) is present in the cathode in an amount of 5 parts by weight based upon 100 parts by weight of the cathode layer.

8. The battery system of claim 1, wherein the solid-state is electrolyte includes the reduction tolerable solid electrolyte and the oxidation tolerable solid electrolyte;
wherein the reduction tolerable solid electrolyte includes Li₇₋ₓLa₃Zr₂₋ₓTaₓO₁₂ (LLZO); and
wherein the oxidation tolerable solid electrolyte includes Li_{1+x+y}AlₓTi₂₋ₓSi_{y}P_{3-y}O₁₂ (LATP).

9. The battery system of claim 8, wherein the Li₇₋ₓLa₃Zr₂₋ₓTaₓO₁₂ (LLZO) is present in the anode in an amount of 1 part by weight based upon 100 parts by weight of the anode layer; and
wherein the Li_{1+x+y}AlₓTi₂₋ₓSi_{y}P_{3-y}O₁₂ (LATP) is present in the cathode in an amount of 5 parts by weight based upon 100 parts by weight of the cathode layer.

10. The battery system of claim 1, wherein the solid-state electrolyte includes the reduction tolerable solid electrolyte material and the oxidation tolerable solid electrolyte;
wherein the reduction tolerable solid electrolyte is intermixed within the anode layer; and
wherein the oxidation tolerable solid electrolyte is intermixed within the cathode layer.

11. The battery system of claim 10, wherein the reduction tolerable solid electrolyte further includes a reduction tolerable solid electrolyte layer next to the anode layer; and
wherein the oxidation tolerable solid electrolyte further includes an oxidation tolerable solid electrolyte layer next to the cathode layer.

12. The battery system of claim 11, wherein the reduction tolerable solid electrolyte layer next to the anode layer has a thickness of from 0.01 micrometer to 5 micrometers; and
wherein the oxidation tolerable solid electrolyte layer next to the cathode layer has a thickness of from 0.01 micrometer to 10 micrometers.

13. The battery system of claim 11, wherein the reduction tolerable solid electrolyte layer next to the anode layer has a thickness of 2 millimeters; and
wherein the oxidation tolerable solid electrolyte layer next to the cathode layer has a thickness of 7 micrometers.

14. The battery system of claim 1, wherein the solid-state electrolyte includes the reduction tolerable solid electrolyte material and the oxidation tolerable solid electrolyte;
wherein the reduction tolerable solid electrolyte includes a reduction tolerable solid electrolyte layer next to the anode layer; and
wherein the oxidation tolerable solid electrolyte includes an oxidation tolerable solid electrolyte layer next to the cathode layer.

15. The battery system of claim 14, wherein the reduction tolerable solid electrolyte layer next to the anode layer has a thickness of from 0.01 micrometer to 5 micrometers; and
wherein the oxidation tolerable solid electrolyte layer next to the cathode layer has a thickness of from 0.01 micrometer to 10 micrometers.

16. The battery system of claim 14, wherein the reduction tolerable solid electrolyte layer next to the anode layer has a thickness of 2 millimeters; and
wherein the oxidation tolerable solid electrolyte layer next to the cathode layer has a thickness of 7 micrometers.

17. The battery system of claim 1, wherein the solid-state electrolyte is the reduction tolerable solid electrolyte and includes a garnet type solid electrolyte.

18. The battery system of claim 1, wherein the solid-state electrolyte is the reduction tolerable solid electrolyte and is selected from the group consisting of a sodium super ionic conductor-type solid electrolyte, a garnet type solid electrolyte, and Li₃ₓLa_{2/3-x}TiO₃.

19. A device comprising:
a motor generator unit of a powertrain; and
a battery system configured for providing electrical energy to the motor generator unit, the battery system including:
a battery cell, including:
an anode including:
a first current collector; and
an anode layer disposed on the first current collector and including an anode active material;
a cathode including:
a second current collector; and
a cathode layer disposed on the second current collector and including a cathode active material;
a solid-state electrolyte selected from at least one of a reduction tolerable solid electrolyte disposed in contact with the anode and an oxidation tolerable solid electrolyte disposed in contact with the cathode;
wherein the reduction tolerable solid electrolyte is present in the battery cell in an amount of from 0.1 part by weight to 5 parts by weight based upon 100 parts by weight of the anode layer; and
wherein the oxidation tolerable solid electrolyte is present in the battery cell in an amount of from 1 part by weight to 10 parts by weight based upon 100 parts by weight of the cathode layer.

20. The device of claim 19, wherein the solid-state electrolyte includes the reduction tolerable solid electrolyte and the oxidation tolerable solid electrolyte;
wherein the reduction tolerable solid electrolyte includes Li₇₋ₓLa₃Zr₂₋ₓTaₓO₁₂ (LLZO); and
wherein the oxidation tolerable solid electrolyte includes Li_{1+x+y}AlₓTi₂₋ₓSi_{y}P_{3-y}O₁₂ (LATP).
